(19) United States
(12) Patent Application Publication
(10) Pub. No.: US 2015/0376036 A1
(43) Pub. Date: Dec. 31, 2015

(54) Apparatus and System for Deionization

(71) Applicant: B.G. Negev Technologies and Applications LTD., Beersheva (IL)

(72) Inventors: Ora KEDEM, Haifa (IL); Rami MESSALEM, Omer (IL); Charles LINDER, Rehovot (IL)

(21) Appl. No.: 14/767,190

(22) PCT Filed: Feb. 10, 2014
(86) PCT No.: PCT/IL2014/050137

§ 371 Date: Aug. 11, 2015

Related U.S. Application Data
(60) Provisional application No. 61/762,966, filed on Feb. 11, 2013.

(51) Int. Cl. C02F 1/469

(52) U.S. Cl. CPC C02F 1/4693; C02F 1/4695; C02F 2201/46115

(57) ABSTRACT

There is provided a membrane module comprising a membrane package comprising at least two membrane sleeves, wherein the membrane package is configured to allow essentially free flow of a first stream inside the sleeves and essentially free flow of a second stream between each two adjacent sleeves, and a frame, configured to support the membrane package, such that part of each of four surfaces of the membrane package is affixed to predetermined areas in the frame, forming a module having separate spaces configured to facilitate separate flows of the first stream and the second stream through the membrane package. The invention further provides a multi-modular stack, comprising at least two membrane modules and at least one membrane, wherein the first stream is fully enclosed inside each module and the second stream flows through all the modules.

### FIELD OF THE INVENTION

The invention relates to devices, apparatus and systems for fluid deionization, for example, as is used in water desalination.

### BACKGROUND

Electrodialysis (ED) is a relatively mature desalting technology invented before reverse osmosis (RO). In pressure driven systems such as RO and nanofiltration (NF) feed water is pressurized to exceed an osmotic pressure, and water passes through a semi-permeable membrane while dissolved solids are rejected and remain on a feed water side, eventually concentrating into a brine solution. The systems driven by electric potential (ED) apply voltage to opposite ends of a membrane package, one positive terminal and one negative. So, while the pressure-driven system selectively passes water and retains dissolved salts, an electrically driven system extracts dissolved salts and retains the water. Either way, the water and salts are separated, producing low salinity water. The potential advantage of ED over RO is its applicability in very high salt concentrations as well as in brackish water, since no high pressures are required for the process; at one time, table salt in Japan was produced for years by ED from seawater. Hence ED can solve a crucial, currently expensive, unsolved problem of brine disposal in the desalting of brackish water. Since ED, unlike reverse osmosis, removes salts from the feed water, and not water from the solutes, it is also particularly advantageous for the treatment of brackish water containing relatively low amounts of salt. ED is used in different applications where the composition of two separate streams flowing through the stack depends on the nature of the process. For example, the feed stream may be a mixed solution containing a valuable product and salts which are to be removed by the ED, and the second stream, to be termed here generally a process stream, will be a solution of the removed salt. In another case, reverse electrodialysis (RED) extracts energy from a concentration difference by permeation of salt from a concentrated feed solution, such as sea water, into surface water or any dilute water source in an ED stack. In this case, the feed stream is for example, seawater and the process stream is, for example, river water. Stacks comprising ion exchange membranes of one kind may be used for ion exchange driven by an electric current, for example all cation exchange stacks, for acidification. In this case the feed is the solution which should be acidified, and the process stream is an acid solution. A process for ion exchange through membranes, so called Donnan dialysis or diffusion dialysis, can be carried out in stacks comprising only cation exchange membranes or only anion exchange membranes.

Usually, ED cannot be carried out in very dilute solutions, because the electric resistance becomes prohibitively high, due to bulk resistance and even more due to strong concentration polarization. This can be overcome by filling diluate compartments with ion exchange resin, usually mixed bed. This process, used for preparation of ultra pure water, is a version of electrodialysis, so-called electro-deionization (EDI) or continuous electro-deionization (CEDI). For some deionization stacks a cation exchange membrane and an anion exchange membrane are sealed to a spacer, and the resulting diluate cell is filled with ion exchange resin.

In currently available commercial ED equipment, the cost of the membrane stack is a large part of the total initial investment. The filter press concept, the expensive membranes and the gaskets all contribute to the high cost of the stack. A less expensive stack would make the process more competitive.

It was previously attempted to decrease the number of separate items in the ED stack by gluing or sealing of elements to each other. For example, it was reported that a sealed cell ED stack was created in which cation exchange and anion exchange membrane were sealed together to form bags with one outlet. Another stack was reported in which each membrane is glued to a separate frame. None of these leads to substantial simplification of the stack or to better operation.

A membrane package for ED stack comprising a plurality of membranes was described in U.S. Patent Application Publication No. 2010/0326833. The membrane package is adapted to allow essentially free flow without mixing of the process and the feed streams. Further provided is a stack, comprising a plurality of membrane packs, wherein the passage of the process and the feed streams proceeds through the tangent planes (sides) of the membrane packs. U.S. Patent Application Publication No. 2010/0326833 is incorporated by reference in its entirety.

There is still a need in the art for efficient membrane stacks, particularly for ED purposes.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

The present invention encompasses a membrane module which includes a membrane package inserted in a frame. The invention further relates to a multi-modular stack, including a plurality of membrane modules. The membrane module and the multi-modular stack may be a part of an apparatus adapted for fluid deionization, in accordance with an embodiment of the invention. The invention further encompasses a method for fluid deionization.

There is provided, according to one aspect, a membrane module, including a membrane package including at least two membrane sleeves, wherein each sleeve includes a first and a second membrane sealed together along two parallel edges of said first and said second membranes, and wherein said two membrane sleeves are connected along two edges perpendicular to the sealed edges of said first and said second membranes, forming two membrane package sides having unsealed sleeve edges, wherein the membrane package is configured to allow essentially free flow of a first stream inside the sleeves and essentially free flow of a second stream between each two adjacent sleeves, wherein the first stream flow is perpendicular to the second stream flow; and a frame, configured to support the membrane package, such that part of at least three surfaces perpendicular to the two membrane package sides having unsealed sleeves edges is affixed to predetermined areas in the frame, leaving the unsealed sleeves open to the flow of the first stream and forming a module having separate spaces configured to facilitate separate flow of the second stream through the membrane package. According to some embodiments of the invention, part of each of the four surfaces perpendicular to the two membrane package sides having unsealed sleeves edges is affixed to predetermined areas in the frame. According to further embodiments, a peripheral part of the four surfaces perpendicular to the two membrane package sides having unsealed sleeves edges is affixed to predetermined areas in the frame. According to still further embodiments, a part of the four surfaces which is affixed to predetermined areas in the frame, is in the close proximity of the membrane package side having unsealed sleeves edges. According to other embodiments, there is provided a membrane module, including a membrane package including at least two membrane sleeves, wherein each sleeve includes a first and a second membrane sealed together along two parallel edges of said first and said second membranes, and wherein said two membrane sleeves are connected along two edges perpendicular to the sealed edges of said first and said second membranes, wherein the membrane package is configured to allow essentially free flow of a first stream inside the sleeves and essentially free flow of a second stream between each two adjacent sleeves, wherein the first stream flow is perpendicular to the second stream flow; and a frame, configured to support the membrane package, such that three surfaces of each of the connected edges of the membrane package are affixed to predetermined areas in the frame, leaving entrance and exit of the sleeves open to flow of the first stream and forming a module having separate spaces configured to facilitate separate flow of the second stream through the membrane package. According to further embodiments of the invention, four surfaces of each of the connected edges of the membrane package are affixed to predetermined areas in the frame.

According to some embodiments, the first membrane and the second membrane are ion exchange membranes. According to further embodiments, the first membrane is a cation exchange membrane. According to still further embodiments, the second membrane is an anion exchange membrane. According to alternative embodiments, the first membrane and the second membrane are cation exchange membranes.

According to some embodiments, the membrane package comprises connected edges. According to some embodiments, the membrane sleeves in the membrane package are connected by means of a connecting material. The connecting material may comprise glue, such as epoxy or other glues. According to some embodiments, the membrane sleeves in membrane package are connected by a potting procedure.

According to some embodiments, the membrane package may further comprise at least two spacers, wherein each spacer is disposed inside each membrane sleeve, and at least one spacer, disposed between two adjacent membrane sleeves. According to further embodiments, the membrane package comprises membrane sleeves on its top and its bottom surfaces. According to further embodiments, the membrane package is configured to allow the flow of the first stream through the spacer disposed inside the membrane sleeve and the flow of the second stream through the spacer disposed between each two adjacent sleeves. According to yet further embodiments, said first stream flow and said second stream flow are not mixing with one another.

According to some embodiments of the invention, the frame comprises distribution compartments on two opposite sides, configured to facilitate the first stream flow through the membrane package. According to further embodiments, the frame comprises recesses on two other opposite sides, configured to facilitate the second stream flow through the membrane package. According to some embodiments, the frame further comprises two supporting regions in its bottom part, configured to support one of the three surfaces of each of the connected edges of the membrane package. According to some embodiments, the membrane module further comprises two additional spacers, disposed on the top and in the bottom of the membrane module, covering the active area of the sleeves surface. According to some embodiments, the spacers are of the thickness of the spacers disposed between two adjacent sleeves of the membrane package. According to further embodiments, the membrane module further comprises two cover plates of the thickness of said spacers, wherein said plates are connected to the fourth surface perpendicular to the two membrane package sides having the unsealed sleeves edges and to the edges of the distribution channels. According to some embodiments, the term “connected to” as used herein may refer to “sealed with”. For example, according to further embodiments, the membrane module further comprises two cover plates of the thickness of said spacers, wherein said plates are sealed with the fourth surface of the connected edges of the membrane package and the edges of the distribution channels.

According to further embodiments, the membrane module is configured to fully enclose the first stream inside the module. According to still further embodiments, the first stream flow into said membrane module and out of said membrane module and the second stream flow into said membrane module and out of said membrane module are conducted in perpendicular planes. According to yet further embodiments, the membrane module is adapted to allow a substantially free flow of the first stream and the second stream through the module. According to still further embodiments, the membrane module comprises a relatively low hydrodynamic resistance to the flow of the first and the second streams.

According to some embodiments, the first stream is a feed stream and the second stream is a process stream. According to other embodiments, the first stream is a process stream and the second stream is a feed stream.

According to some embodiments, the membrane module is configured to be used for fluid deionization. According to further embodiments, the membrane module is configured to be used in electrodialysis ED, electrodialysis reverse ED (EDR), Donnan Dialysis, Electro-deionization (EDI), Continuous Electro-deionization (CEDI), and/or Reversed Electrodialysis (RED), or any combination thereof. According to still further embodiments, the membrane module is configured to be used for diluting and/or concentrating a solution in a desalination process.

There is provided, according to another aspect, a multi-modular stack, comprising at least two membrane modules and at least one membrane, disposed between the membrane modules, wherein each membrane module includes a membrane package including at least two membrane sleeves, wherein each sleeve includes a first and a second membrane sealed together along two parallel edges of said first and said second membranes, and wherein said two membrane sleeves are connected along two edges perpendicular to the sealed edges of said first and said second membranes, forming two membrane package sides having unsealed sleeve edges, wherein the membrane package is configured to allow essentially free flow of a first stream inside the sleeves and essentially free flow of a second stream between each two adjacent sleeves, wherein the first stream flow′ is perpendicular to the second stream flow; and a frame, configured to support the membrane package, such that part of each of the four surfaces perpendicular to the two membrane package sides having unsealed sleeves edges is affixed to predetermined areas in the frame, leaving the unsealed sleeves open to the flow of the first stream and forming a module having separate spaces configured to facilitate separate flow of the second stream through the membrane package. According to some embodiments, the membrane is configured to allow free from leakage flow of the second stream through the membrane modules. According to further embodiments, the multi-modular stack comprises at least one o-ring disposed between said membrane modules. According to some embodiments, the membrane and the o-ring are configured to allow free from leakage flow of the second stream through the membrane modules.

According to some embodiments, the second stream passes through all the modules and the first stream is divided between all the modules, wherein each portion of the first stream enters specific module and is confined inside each module. According to further embodiments, the flow of the first stream and of the second stream across the stack is conducted in perpendicular planes. According to still further embodiments, each membrane module is readily removable and interchangeable.

According to some embodiments, the first stream is a feed stream and the second stream is a process stream. According to other embodiments, the first stream is a process stream and the second stream is a feed stream.

According to some embodiments, the multi-modular stack is configured to be used for fluid deionization. According to further embodiments, the multi-modular stack is configured to be used in electrodialysis ED, electrodialysis reverse ED (EDR), Donnan Dialysis, Electro-deionization (EDI), Continuous Electro-deionization (CEDI), and/or Reversed Electrodialysis (RED), or any combination thereof. According to still further embodiments, the multi-modular stack is configured to be used for diluting and/or concentrating a solution in a desalination process.

There is provided, according to some embodiments, an apparatus for use in fluid deionization, including the multi-modular stack, wherein the multi-modular stack includes at least two membrane modules and a least one membrane, disposed between the membrane modules. According to some embodiments, the apparatus may be used in electrodialysis ED, electrodialysis reverse ED (EDR), Donnan Dialysis, Electro-deionization (EDI), Continuous Electro-deionization (CEDI), and/or Reversed Electrodialysis (RED), or any combination thereof. There is further provided, according to some embodiments, a water treatment system, including the apparatus for use in fluid deionization.

There is provided, according to another aspect a method for fluid deionization, including passing a first stream and a second stream through a membrane module, comprising at least one membrane package and a frame, wherein the first stream flow to the membrane package is conducted through distribution compartments disposed on two opposite sides of the frame and the second stream flow to the membrane package is conducted through recesses disposed on two other opposite sides of the frame.

The method for fluid deionization may further include passing a first stream and a second stream through a multi-modular stack, including at least two membrane modules and at least one membrane, disposed between the modules, wherein the first stream flow is divided between all modules of the multi-modular stack and the second stream flow is conducted through all modules and the membranes of the multi-modular stack.

According to some embodiments, the first stream is a feed stream and the second stream is a process stream. According to other embodiments, the first stream is a process stream and the second stream is a feed stream.

According to some embodiments, the method for fluid deionization is for use in diluting and/or concentrating a solution in a desalination process. According to some embodiments, the method for fluid deionization is for use in electrodialysis ED, electrodialysis reverse ED (EDR), Donnan Dialysis, Electro-deionization (EDI), Continuous Electro-deionization (CEDI), and/or Reversed Electrodialysis (RED), or any combination thereof.

In addition to the exemplary aspects and embodiments described above, further aspects and embodiments will become apparent by reference to the figures and by study of the following detailed description.

### BRIEF DESCRIPTION OF THE FIGURES

Examples illustrative of embodiments of the invention are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale.

The figures are listed below.

FIG. 1A schematically illustrates an exploded isometric view of a membrane package, in accordance with an embodiment of the invention;

FIG. 1B schematically illustrates an isometric view of the membrane package of FIG. 1A, in a packed form, in accordance with an embodiment of the invention;

FIG. 2A schematically illustrates an isometric view of an exemplary frame, in accordance with an embodiment of the invention;

FIG. 2B schematically illustrates an isometric view of a membrane package of FIG. 2A inserted into an exemplary frame of FIG. 2A, in accordance with an embodiment of the invention;

FIG. 3A schematically illustrates an isometric view of an exemplary membrane module, in accordance with an embodiment of the invention;

FIG. 3B schematically illustrates an isometric view of an exemplary membrane stack, in accordance with an embodiment of the invention;

FIG. 4 schematically illustrates a flow chart of an exemplary mode of operation of the membrane stack shown in FIG. 3B, in accordance with an embodiment of the invention; and

FIG. 5 schematically illustrates an isometric view of an exemplary multi-modular stack, in accordance with an embodiment of the invention;

### DETAILED DESCRIPTION

### Glossary

Unless otherwise noted, or as may be evident from the context of their usage, any terms, abbreviations, acronyms or scientific symbols and notations used herein are to be given their ordinary meaning in the technical discipline to which the disclosure most nearly pertains. The following terms, abbreviations and acronyms may be used throughout the descriptions presented herein and should generally be given the following meaning unless contradicted or elaborated upon by other descriptions set forth herein. When glossary terms (such as abbreviations) are used in the description, no distinction should be made between the use of capital (uppercase) and lowercase letters. For example “ABC”, “abc” and “Abc”, or any other combination of upper and lower case letters with these 3 letters in the same order, should be considered to have the same meaning as one another, unless indicated or explicitly stated to be otherwise. The same commonality generally applies to glossary terms (such as abbreviations) which include subscripts, which may appear with or without subscripts, such as “X_{yz}” and “Xyz”. Additionally, plurals of glossary terms may or may not include an apostrophe before the final “s”—for example, ABCs or ABC's.

Compartment may refer to, according to some embodiments, a volume defined by a spacer disposed inside a membrane sleeve or between sleeves.

Concentrate may refer to, according to some embodiments, a process stream in desalination, or other ED processes concentrating a salute.

Cross linking or cross-link may refer to, according to some embodiments, the formation of covalent bonds linking one polymer and/or oligomer chain to another. Cross linking may also be brought about by interactions other than covalent bonds such as electrostatic or hydrophobic interactions. Unless otherwise stated, cross linking refers to covalent bonds.

Diluate, according to some embodiments, is an alternative term for feed stream in ED desalination.

Electro-deionization (EDI) may refer to, according to some embodiments, a process for desalting of dilute saline solutions using membrane packages in which the feed (diluate) compartment or both feed and process compartments, is at least partially filled with ion exchange resin.

Electrode or electrode housing may refer to a sealed unit comprising electrodes, electrode rinse solutions an ion exchange membrane sealing the circulating rinse solution.

Electrodialysis may refer to, according to some embodiments, a process comprising transferring ions through semi-permeable membranes, driven by an electric potential.

Electrodialysis Reversal (EDR) may refer to, according to some embodiments, an electrodialysis process in which the direction of the electric current is reversed at predetermined intervals.

Electrodialysis (ED) stack may refer to, according to some embodiments, a stack containing membranes and spacers (usually connected) allowing the flow of at least two solutions; a frame adapted to accommodate membranes and spacers, electrodes enabling electric flow through membranes and solutions and serving as end plates; and means to keep these together.

End plates may refer to, according to some embodiments, plates (for example, flat plates) at one or both ends of the ED stack, held together (for example, mechanically). Sealed electrode housings may serve as end plates in a stack

Feed compartment may refer to, according to some embodiments, a volume defined by a spacer disposed inside the membrane sleeve.

Feed stream may refer to, according to some embodiments, a solution to be processed by electrodialysis, flowing through feed compartments.

Free flow may refer to, according to some embodiments, an entrance and exit of the fluid stream into compartments defined by spacers disposed inside or between membrane sleeves, essentially through the entire cross-section of the spacer.

Hydrodynamic resistance may refer to, according to some embodiments, a ratio between an applied pressure and a flow, for example, flow as expressed by a linear velocity of a solution passing through a stack.

Inner side of anion exchange membrane may refer to, according to some embodiments, to a side forming an inner part of a membrane sleeve.

Inner side of cation exchange membrane may refer to, according to some embodiments, to a side forming an inner part of a membrane sleeve

Ion exchange membranes may refer to, according to some embodiments, membranes designed for transfer of ions. They carry fixed charges, for example, they may contain polymers which carry ionic groups. Electro neutrality is maintained by mobile counter-ions of opposite sign to that of the polymer, cations in cation exchange membranes and anions in anion exchange membranes. Co-ions are ions of the same sign as the polymer

Ionomers may refer to, according to some embodiments, polymers containing both hydrophilic charged groups and hydrophobic groups. Ionomers are generally soluble in organic solvents and insoluble in water.

Membrane package may refer to, according to some embodiments, a plurality of membrane sleeves and spacers, in which all elements are suitably connected together.

Module (membrane module) may generally refer to, according to some embodiments, connected groups of elements such as membrane package and frame. Modules may include a membrane package, fastened in a frame.

Outer side of anion exchange membrane may refer to, according to some embodiments, a side forming an outer side of a membrane sleeve.

Outer side of cation exchange membrane may refer to, according to some embodiments, a side forming an outer side of a membrane sleeve.

Permselectivity of a membrane may refer to, according to some embodiments, discrimination between cations and anions. In a highly perm selective membrane, electric current is carried mostly by ions of one sign and by only a small amount of ions of an opposite sign.

Potting may refer to, according to some embodiments, a procedure comprising binding membrane package elements such as membranes, membrane sleeves or spacers into one body by a connecting material, so that subsequently some predetermined spaces in or between the membrane package elements can remain accessible and others blocked to one of the streams.

Process compartment may refer to, according to some embodiments, a volume defined by a spacer disposed between two adjacent membrane sleeves.

Process stream may refer to, according to some embodiments, a solution flowing through compartments alternate to the feed stream.

Reversed Electrodialysis (RED) may refer to, according to some embodiments, a process in which the free energy of a concentration gradient is converted into electric energy by allowing diffusion of salt from a solution of high concentration to low concentration through an electrodialysis stack

Seal (sealing) may refer to, according to some embodiments, a tight (generally) permanent adherence between limited areas of two membranes or a spacer, and one or two membranes, and the process creating this adherence. Sealing may be achieved by glue or thermal sealing or potting or any other suitable method.

Sealing or gluing or potting may also refer to any mode of permanent connection between elements such as, for example, membranes, membrane sleeves and spacers, membrane package and spacers, membrane package and frame, and closure plates.

Shape-stable membranes may refer to, according to some embodiments, membranes which have essentially equal length dimensions in dry and wet states.

Sleeves (membrane sleeves) may refer to, according to some embodiments, two membranes sealed along at least two parallel edges, possibly sealed with a spacer between them. The membranes may be sealed together by glue or thermal sealing or any other suitable method. The membranes may be sealed together by strips along the edges.

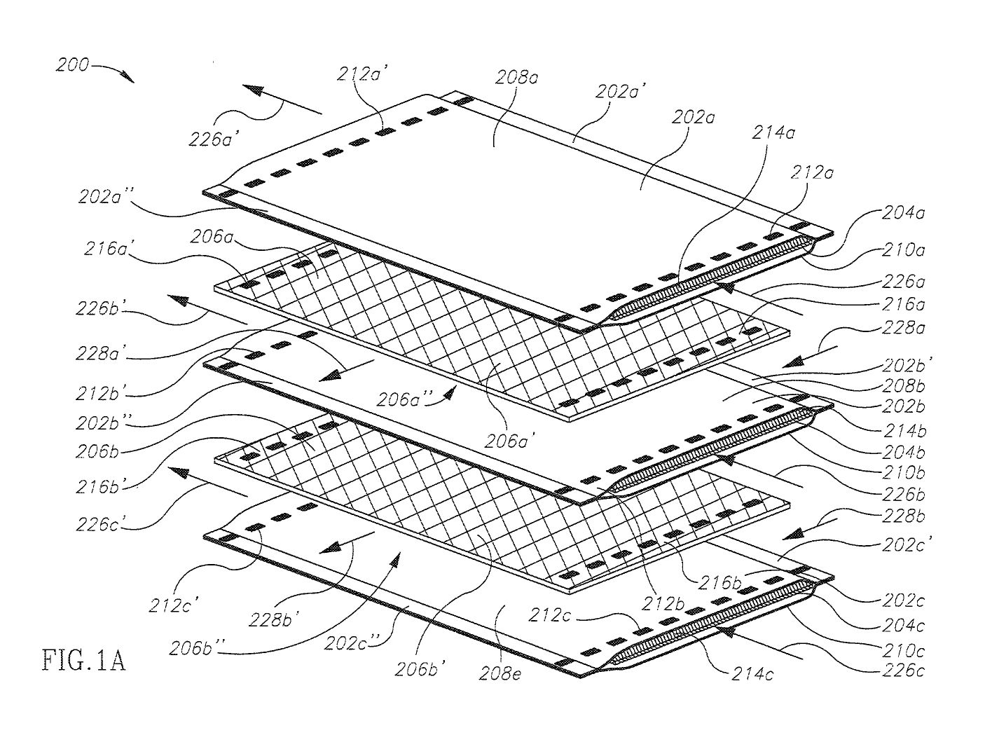

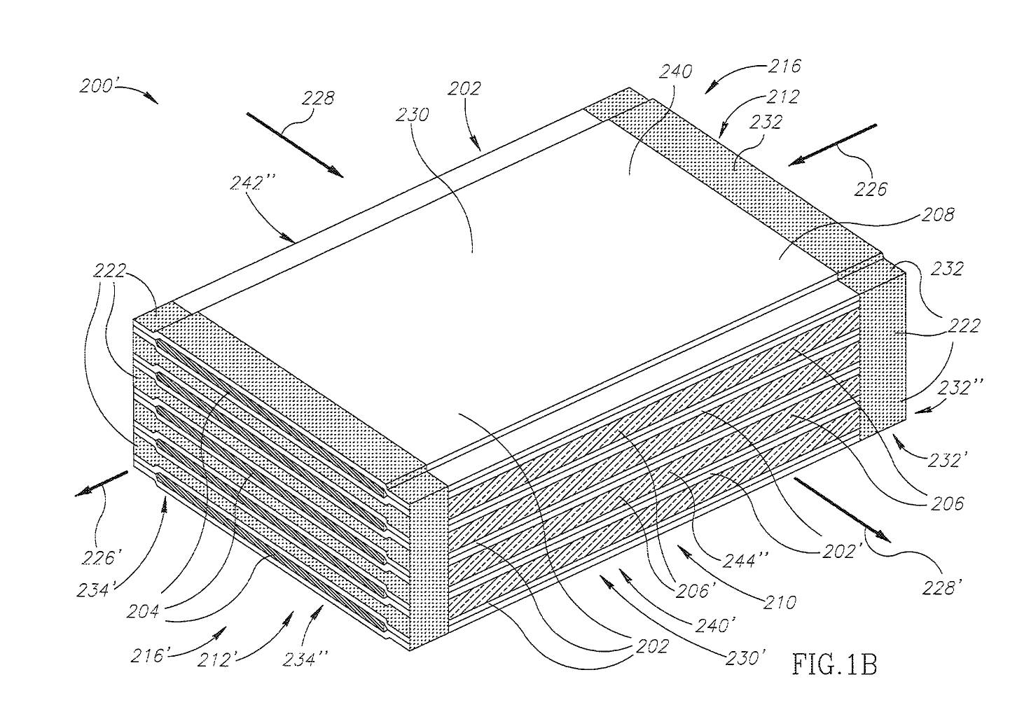

Reference is made to FIG. 1A which schematically illustrates an exploded isometric view of a membrane package 200, in accordance to some embodiments. A membrane package, such as membrane package 200, may be a part of a membrane module, which may be a part of an apparatus adapted for diluting and/or concentrating a solution in a desalination process, in accordance with an embodiment of the invention. Optionally, the apparatus may form an acid and/or a basic solution in a neutralization process; diffuse a concentrated solution and a more dilute water source in an energy conversion process; selectively move ions in a solution, or optionally de-ionize the solution, as may be required by a desired process; and/or any combination thereof. Said apparatus may be adapted for use in processes such as ED, EDR, Donnan Dialysis, EDI, CEDI, and the like.

Membrane package 200 includes a plurality of membrane sleeves (generally referred to as membrane sleeves 202) such as membrane sleeves 202a, 202b and 202c. Membrane package 200 may include two, three, four or more (such as tens or hundreds) of sleeves, for example 2-10 sleeves, 10-20 sleeves, 20-40 sleeves, 40-80 sleeves, 80-160 sleeves, 160-320 sleeves, and optionally more than 320 sleeves. Sleeve 202 comprises two ion exchange membranes, a cation exchange membrane (generally referred to as cation exchange membranes 208) and an anion exchange membrane (generally referred to as anion exchange membranes 210). Optionally, sleeve 202 may comprise a second cation exchange membrane (such as exchange membrane 208) instead of anion exchange membrane 210 (not shown), for example, for the apparatus use for acidification processes and/or Donnan dialysis. Optionally, sleeve 202 may comprise a second anion exchange membrane (such as 210 anion exchange membrane) instead of cation exchange membrane 208 (not shown), for the apparatus use for Donnan dialysis. For example, membrane sleeve 202a comprises cation exchange membrane 208a and anion exchange membrane 210a, membrane sleeve 202b comprises cation exchange membrane 208b and anion exchange membrane 210b and membrane sleeve 202c comprises cation exchange membrane 208c and anion exchange membrane 210c.

In accordance with an embodiment of the invention, sleeve 202a may be formed by attaching the inner side of cation exchange membrane 208a to the inner side of anion exchange membrane 210a along two opposing, parallel edges such as edge 202a′ and opposite edge 202a″. Sleeves 202b and 202c may be formed in the same manner, attaching the inner side of cation exchange membrane 208b to the inner side of anion exchange membrane 210b; and the inner side of cation exchange membrane 208c to the inner side of anion exchange membrane 210c along two opposing, parallel edges: edge 202b′ and opposite edge 202b″ and edge 202c′ and opposite edge 202c″ respectively.

In accordance with an embodiment of the invention, membrane sleeves 202 include spacers (generally referred to as spacers 204) inside them. For example, membrane sleeves 202a, 202b and 202c include spacers 204a, 204b and 204c respectively. In accordance with an embodiment of the invention, spacer 204a is placed inside sleeve 202a and optionally attached to the inner side of cation exchange membrane 208a and to the inner side of anion exchange membrane 210a along the sealed edges—edge 202a′ and opposite edge 202a″ of sleeve 202a. Spacers 204b and 204c are placed inside sleeves 202b and 202c respectively. Spacer 204b is optionally attached to the inner side of cation exchange membrane 208b and to the inner side of anion exchange membrane 210b along the sealed edges—edge 202b′ and opposite edge 202b″ of sleeve 202b. Spacer 204c is optionally attached to the inner side of cation exchange membrane 208c and to the inner side of anion exchange membrane 210c along the sealed edges—edge 202c′ and opposite edge 202c″ of sleeve 202c.

Sealed edges 202a′, 202b′, 202c′ of sleeves 202a, 202b and 202c are generally referred to as edges 202′. The opposite sealed edges of the sleeves (202a″, 202b″ and 202c″) are generally referred to as edges 202″.

Cation exchange membrane 208 and/or anion exchange membrane 210 may comprise shape-stable ion exchange membranes, the membranes adapted to maintain their linear dimensions in both dry and wet conditions to within 10% or less. Optionally, the dimensions are maintained to within a range of 5%-10% in both dry and wet conditions. Optionally, the dimensions are maintained to within a range of 2%-5% in both dry and wet conditions. Optionally, the dimensions are maintained to 2% or less in both dry and wet conditions. Change of dimensions may be minimized by limited swelling of the polymer material by cross linking and/or by a dimensionally stable membrane support. Cation exchange membrane 208 and/or anion exchange membrane 210 may comprise a thickness in a range from 25μ to 1 mm.

In some embodiments of the invention, the shape-stable membranes may be achieved by combining an ion exchange material known as ionomers, macromolecules in which a small but significant proportion of the constitutional units have ionizable or ionic groups, negative or positive or both, with an uncharged hydrophobic polymer. This combination provides for a membrane displaying substantially reduced swelling and relatively good conductance. Swelling may be decreased by increasing an inert polymer fraction in the combination. Optionally, swelling may be further suppressed by cross-linking or by mixing with uncharged polymer(s). Furthermore, due to mechanical properties of these polymers, membrane resistance may be kept sufficiently low by decreasing the thickness of the membrane (the thickness of the membrane may be, for example 20 micrometer-1 mm, such as 30-50 micrometer).

The uncharged polymer may be chosen from aromatic engineering plastics, as described below, such as polysulfone, polyethersulfone, polyphenylsulfone, polyetherether ketone. The ionomers may be produced by modification of these polymers. The uncharged polymer may be chosen from aromatic engineering plastics, as described below, such as polysulfone, polyethersulfone, polyphenylsulfone, polyetherether ketone. The ionomers may be produced by modification of these polymers or by synthesis from their monomer units, as may be found, for example, in US patent application 2006/0036064 by McGrath et al, which is incorporated herein by reference in its entirety.

In some embodiments of the invention, combinations of the ionomer and the uncharged polymer may be supported on a fabric or other reinforcement structure where there is relatively good adherence of the polymers to the support. Optionally, adherence of the polymers to the embedded support may be enhanced by choosing networks made from polymers, plastic, inorganic fibers, and the like, which are compatible with either the ionomer and/or the non-charged hydrophobic polymer.

In some embodiments of the invention, shape-stable membranes may be formed from cross linking an ion exchange polyelectrolyte, (a macromolecule in which a substantial portion of the constitutional units have ionizable or ionic groups, or both) alone, or optionally within an inert matrix using methods known in the art. For example, copolymerization of vinyl aromatic polymers such as styrene (followed by sulfonation after polymerization) or styrene sulfonic acid with di-vinyl benzene, may yield cross linked cation ion exchange membranes; or a similar polymerization of halogenated (such as, for example chloro or bromo)-methylated styrene with di-vinylbenzene and the subsequent quaternization reaction with tertiary amines and the bromo-methyl groups to yield anion exchange membranes. This may be done in combination with the presence of a net or porous support which is embedded in the final polymer film. Optionally, the formulation may comprise a non-derivatized hydrophobic polymer, such as in commercial membranes, polyvinyl chloride, polyethylene-styrene-butadiene rubber and others. This mixture of inert polymers and the monomers may be coated on a fabric support, and polymerization is then carried out. In both cases of the support and hydrophobic polymer, the materials are chosen to have at least some interfacial compatibility with the cross linked ion exchange polymers for good mechanical strength and minimization of relatively large pores or pin holes. These approaches and other forms of stable membranes are described in H. Strathmann, “Ion Exchange Membrane Separation Processes”, Membrane Science and Technology Series, 9, Elsevie 2004, incorporated herein by reference in its entirety.

In some embodiments of the invention, the following polymers may be used as a hydrophobic polymer matrix, and/or as the starting polymer which is derivatized to form an ionomer by introducing ionic groups, to form the shape stable membranes: those made from condensation polymerization, such as polysulfone, polyether sulfone, polyphenylene sulfone, poly-ether-ketone, polyether-ether-ketone, polyether ketone-ether-ketone, polyphenylene sulfide, polyphenylene sulfone and variations of sulfide and sulfone in the same polymer and other variations of polyether ketones and poly-sulfone. Optionally, some of the categories of the ionic polymers may be derived from a polysulfone (PSU), polyphenylene oxide (PPO), polyphenylene sulfoxide (PPSO), polyphenylene sulfide (PPS), polyphenylene sulfide sulfone (PPS/SO.sub.2), poly-para-phenylene (PPP), poly-phenyl-quinoxaline (PPQ), poly-aryl-ketone (PK) and polyether-ketone (PEK) polymer, polyethersulfone (PES), polyether-ether-sulfone (PEES), polyarylethersulfone (PAS), polyphenylsulfone (PPSU) and poly-phenylene-sulfone (PPSO.sub.2) polymer; the polyimide (PI) polymer may comprise a polyetherimide (PEI) polymer; the polyether-ketone (PEK) polymer may comprise at least one of a polyether-ketone (PEK), polyether-ether-ketone (PEEK), polyether-ketone-ketone (PEKK), polyether-ether-ketone-ketone (PEEKK) and polyether-ketone-ether-ketone-ketone (PEKEKK) polymer; and the polyphenylene oxide (PPO) polymer may comprise a 2,6-diphenyl PPO or 2,6-dimethyl PPO polymer. Polyether-ketone polymers may include polyether-ketone (PEK), polyether-ether-ketone (PEEK), polyether-ketone-ketone (PEKK), polyether-ether-ketone-ketone (PEEKK) and polyether-ketone-ether-ketone-ketone (PEKEKK) polymers.

In some embodiments of the invention, homopolymers and/or copolymers may be used, for example, random copolymers, such as RTM, Victrex 720 P and RTM.Astrel. Optionally, polymers used may include polyaryl ethers, polyaryl thioethers, polysulfones, polyether ketones, polypyrroles, polythiophenes, polyazoles, phenylenes, polyphenylene-vinylenes, polyazulenes, polycarbazoles, polypyrenes, poly-indophenines and polyaryl ethers. Examples of commercial sources for the homopolymers and/or copolymers may include Solvay, ICI, and BASF. Some examples of commercial homopolymers and/or copolymers include UDEL™ polysulfone, RADEL™ A polyether sulfone, RADEL™ R polyphenylsulfone, and SOLEF™ fluoro-polymer produced by Solvay.

The anionic groups, on the cation exchange ionomers, may include sulfonic, carboxylic, and phosphonic. Optionally, sulfonated, carboxylated or phosphonated may be derived from polyphenylsulfone, polyether-ketone, polyetheretherketone polypropylene, polystyrene, polysulfone, polyethersulfone, polyetherethersulfone, polyphenylenesulfone, poly(bisbenzoxazol-1,4-phenylene), poly(bisbenzo (bis-thiazol)-1,4-phenylene), polyphenyleneoxide, polyphenylenesulfide, polyparaphenylene. Optionally, polytrifluorostyrene sulfonic acid, polyvinylphosphonic acid, and polystyrene sulfonic acid may be used. Some non-limiting examples of sulfonated ionomers and their degree of substitution are: Sulfonated polyphenylsulfone 0.8 to 2.5 meq/gr., Sulfonated polysulfone 0.8, to 1.8, Sulfonated polyether sulfone 0.6, to 1.4, Sulfonated polyether ether ketone 1.0 to 3.0, Sulfonated polyether ketone 0.8, to 2.5. Sulfonated PVDF and sulfonated PVDF copolymers of 1.0 to 2.5 meq/gr. Optionally, counter ions of the ionomer or polyelectrolyte ionic groups may be chosen during fabrication of the membrane or during their use. Examples may include H+, Li+, K+, Na+, and NH₄+, and multivalent ions which may include, for example, Ca, Mg, and Zn ions.

Optionally, ionomers with cationic exchange groups may be chosen from quaternary ammonium, phosphonium and sulfonium. These may be made by methods known in the art, such as, for example (but not limited to), the derivation of the aromatic condensation polymer, such as polysulfone to form halomethylated polymers which may be converted to quaternary ammonium, phosphonium and sulfonium derivatives. Optionally, poly-4-vinylpyridine cross linked with dibromo or chloro alkanes with quaternization of the remaining pyridines with methyliodide, may be used.

In some embodiments of the invention, membranes may be formed by casting the polymer on a reinforcing material or substrate. Such substrate may be chosen from woven synthetic fabrics such as polypropylene cloth, polyacrylonitrile cloth, polyacrylonitrile-co-vinyl chloride cloth, polyvinyl chloride cloth, polyester cloth, and the like. Optionally, other substrates may include glass filter cloth, polyvinylidene chloride screen, glass paper, treated cellulose battery paper, polystyrene-coated glass fiber mat, polyvinyl chloride battery paper, and the like.

Membrane package 200 further includes spacers (generally referred to as spacers 206) disposed between two adjacent sleeves. For example, spacers 206a and 206b are disposed between two adjacent sleeves 202a and 202b; and 202b and 202c, respectively. Spacers 204 and 206 may be the same or different.

Spacer 206a is attached to anion exchange membrane 210a of sleeve 202a and to cation exchange membrane 208b of sleeve 202b, such that first side 206a′ of spacer 206a is attached to the outer side of anion exchange membrane 210a of sleeve 202a and second side 206a″ of spacer 206a is attached to the outer side of cation exchange membrane 208b of sleeve 202b, along two opposing, parallel edges perpendicular to the attached edges (edge 202a′ and opposite edge 202a″ and edge 202b′ and opposite edge 202b″) of sleeves 202a and 202b: edge 216a of spacer 206a is attached to edge 212a of anion exchange membrane 210a of sleeve 202a and edge 216a′ of spacer 206a is attached to edge 212a′ of anion exchange membrane 210a of sleeve 202a; and edge 216a of spacer 206a is attached to edge 212b of cation exchange membrane 208b of sleeve 202b and edge 216a′ of spacer 206a is attached to edge 212b′ of cation exchange membrane 208b of sleeve 202b. Spacer 206b is attached to anion exchange membrane 210b of sleeve 202b and to cation exchange membrane 208c of sleeve 202c, such that first side 206b′ of spacer 206b is attached to the outer side of anion exchange membrane 210b of sleeve 202b and second side 206b″ of spacer 206b is attached to the outer side of cation exchange membrane 208c of sleeve 202c, along two opposing, parallel edges perpendicular to the attached edges (edge 202b′ and opposite edge 202b″; and edge 202c′ and opposite edge 202c″) of sleeves 202b and 202c: edge 216b of spacer 206b is attached to edge 212b of anion exchange membrane 210b of sleeve 202b and edge 216b′ of spacer 206b is attached to edge 212b′ of anion exchange membrane 210b of sleeve 202b; and edge 216b of spacer 206b is attached to edge 212c of cation exchange membrane 208c of sleeve 202c and edge 216b′ of spacer 206b is attached to edge 212c′ of cation exchange membrane 208c of sleeve 202c.

Edges 212a, 212b, 212c of sleeves 202a, 202b and 202c are generally referred to as edges 212. The opposite open edges of the sleeves (212a′, 212b′ and 212c′) are generally referred to as edges 212′. Edges 212 and edges 212′ are the open edges of sleeves 202.

Edges 214a, 214b, 214c of spacers 204a, 204b and 204c are generally referred to as edges 214. Edges 216a and 216b of spacers 206a and 206b are generally referred to as edges 216. Edges 216a′ and 216b′ of spacers 206a and 206b are generally referred to as edges 216′. The opposite parallel edges 206a′ and 206b′; and 206a″ and 206b″ of spacers 206a and 206b are generally referred to as edges 206′ and 206″ respectively.

Methods used for sealing of sleeves edges 202′ and 202″ of membrane sleeves 202 include, for example, thermal sealing; adhering by glue, epoxies, and the like; cross linking of polymers comprised in a sealing solution and the ion exchange membranes 208 and 210. Cation exchange membrane 208 and anion exchange membrane 210 forming sleeve 202 may be attached by means of a connecting element, such as, for example, adhesive strips of thickness ranging 2-4 mm. Methods used for attaching spacers 204 and spacers 206 to sleeves 202 may comprise use of the same methods used for sealing the sleeves edges, but generally with different technology including potting, for example, silicon potting, resin potting, adhesive potting, and the like. Optionally, other methods known in the art may be used for sealing sleeves edges and attaching spacers.

In some embodiments of the invention, membrane package 200 may be adapted for EDI and/or CEDI. Cation exchange membrane 208 and anion exchange membrane 210 are attached to each other by a connecting element which may comprise, for example, adhesive strips of thickness ranging 2-4 mm or by a potting procedure. The sleeve 202 may be formed by attaching the inner side of cation exchange membrane 208a to the inner side of anion exchange membrane 210a along two opposing, parallel edges such as edge 202a′ and opposite edge 202a″. Wide spacer 204a may be placed inside the sleeve and connected to cation exchange membrane 208a and anion exchange membrane 210a by means of the same or optionally a different connecting element or material. Wide spacer 206a may be attached to anion exchange membrane 210a of sleeve 202a and to cation exchange membrane 208b of sleeve 202b, such that first side 206a′ of spacer 206a is attached to the outer side of anion exchange membrane 210a of sleeve 202a and second side 206a″ of spacer 206a is attached to the outer side of cation exchange membrane 208b of sleeve 202b, along two opposing, parallel edges perpendicular to the attached edges (edge 202a′ and opposite edge 202a″ and edge 202b′ and opposite edge 202b″) of sleeves 202a and 202b, by means of the same or optionally a different connecting element. A width of the spacers is chosen to allow introduction of an ion exchange resin in a pressurized solution (without interfering with a stability of the resin bed). Optionally, spacers 204a and 206a are not used. Optionally, heterogeneous membranes comprising ion exchange resin embedded in an inert matrix may be used. The membranes may be sealed in dry or wet state using for the sealing a polymer of a lower glass temperature, T_{g}, compatible with the matrix polymer, such as for example “Engage” polymer for sealing of a matrix containing polyethylene. The strips comprise polymers compatible with the membranes. Membrane packages may be prepared by the methods described above, and a net may be glued to one edge of the package. Through the opposite edge, the sleeves are filled with ion exchange resin by pouring a suspension of the resin through the package until the sleeves are filled with resin. The membrane package is then sealed with a net.

Membrane package 200 may be constructed to a predetermined thickness/number of membrane sleeves 202, by inserting spacers 204 inside the sleeves and attaching spacers 206 to each two adjacent sleeves 202, wherein the membrane package comprises sleeves 202 at both of its ends. The mode of connection of spacers 204 and spacers 206 to the sleeves creates perpendicular flow paths for a feed stream (generally referred to as feed stream 226) and a process stream (generally referred to as process stream 228), as shown by arrows 226a, 226b and 226c; and 228a and 228b, respectively. Optionally, arrows 226 and arrows 228 may represent a flow path for the process stream and the feed stream, respectively. Furthermore, the flow path of the feed stream (generally referred to as feed stream 226′) flowing out of spacer 204 is essentially perpendicular to the flow path of the process stream (generally referred to as feed stream 226′) flowing out of spacers 206. Feed stream 226a may flow into spacer 204a along a whole length of an unsealed edge 214a, and may flow out along a whole length of the opposite unsealed edge, as indicated by arrow 226a′. Process stream 228a may flow into spacer 206a along a whole length of an unsealed edge 206a′ and may flow out along the whole length of an opposite unsealed edge 206a″, as indicated by arrow 228a′, essentially perpendicularly to the flow of the feed stream. Feed streams 226b and 226c may flow into spacers 204b and 204c along a whole length of unsealed edges 214b and 214c respectively, and may flow out along a whole length of the opposite unsealed edges, as indicated by arrows 226b′ and 226c′. Process stream 228b may flow into spacer 206b along a whole length of an unsealed edge 206b′ and may flow out along the whole length of an opposite unsealed edge 206b″, as indicated by arrow 228b′, essentially perpendicularly to the flow of the feed stream.

A plurality of sleeves may be stacked together to form membrane package 200. According to one method sleeves 202 sealed along two parallel edges 202′ and 202″ and containing spaces 204 inside thereof and spacers 206 between thereof, may be connected along two parallel unsealed edges 212′ and 212″, which are perpendicular to said sealed edges. The connecting material may comprise glue, such as epoxy or other glues. Membrane package 200′, containing connected sleeves is further described in FIG. 1B.

Reference is made to FIG. 1B, which schematically illustrates an isometric view of an exemplary membrane package 200′. A membrane package, such as membrane package 200′, may be a part of a membrane module, which may be a part an apparatus adapted for diluting and/or concentrating a solution in a desalination process, in accordance with an embodiment of the invention.

Membrane package 200′ comprises a plurality of sleeves 202, each comprising spacer 204 disposed between membrane 208 membrane 210 of sleeve 202, and spacers 206, disposed between each two adjacent sleeves, wherein the sleeves and the spacers are attached to one another by connecting material 222. All components and the connecting material 222 form compact blocks on the two sides of the membrane package containing both membranes and spacers. The outer edges of these blocks reveal the edges of spacers 204, opening the flow path inside sleeves 202 through spacers 204. Edges 216 and 216′ of spacers 206 are covered by the connecting material, eliminating the flow between sleeves 202 and through spacers 206 of the stream entering through the connected edges of membrane package 200″.

According to some embodiments, the connecting procedure further comprises forming protrusions formed from the connecting material to the sides of the connected region. These protrusions allow additional anchoring of the membrane package in the frame into which it is inserted, as will be described hereafter. The connecting material may comprise glue, such as epoxy or other glues. Connecting material 222 provides structural rigidity to membrane package 200′.

According to some embodiments, the connecting procedure may include potting. During potting, edges 212′ and the opposite edges of sleeves 202 and edges 216 and 216′ of spacers 206 are immersed in the connecting material. The outer edges of blocks formed by the connecting material, containing the open sleeves edges, are cut open, revealing the edges of spacers 204, thereby opening the flow path inside sleeves 202 through spacers 204. Edges 216 and 216′ of spacers 206 remain covered by the connecting material, eliminating the flow between the sleeves and through spacers 206 of the stream entering through the potted edges of membrane package 200′.

Membrane package 200′ may comprise for example 2-10 sleeves, 10-20 sleeves, 20-40 sleeves, 40-80 sleeves, 80-160 sleeves, 160-320 sleeves, and optionally more than 320 sleeves. Membrane package 200′ comprises top surface 240 and bottom surface 240′. Top surface 240 may comprise cation exchange membrane 208 or anion exchange membrane. Bottom surface 240′ may comprise cation exchange membrane 208 or anion exchange membrane 210. Membrane package 200′ further comprises two opposing edges 232″ and 234″. Top surface 240 of membrane package 200′ comprises active area 230 and surfaces 232 and 234 of the two connected regions located along two opposing edges 232″ and 234″. Bottom surface 240′ of membrane package 200′ comprises active area 230′ and two surfaces 232′ and 234′ of the two connected regions located along two opposing edges 232″ and 234″. Two opposing edges 232″ and 234″, connected by means of connecting material 222, contain open edges 212 and 212′ of sleeves 202 and spacers 204 disposed inside sleeves 202. Edges 216 and 216′ of spacers 206 are sealed by connecting material 222. The two other opposing edges 242″ and 244″ of membrane package 200′, which are perpendicular to opposing connected edges 232″ and 234″, contain sealed edges 202′ and 202″ of sleeves 202 and exposed edges 206′ and 206″ of spacers 206 disposed between sleeves 202. The feed stream may flow into membrane package 200′ along a whole length of connected edge 232″ as indicated by arrow 226, flow across unsealed spacers 204 and flow out along a whole length of the opposite connected edge 234″, as indicated by arrow 226′. The process stream may flow into membrane package 200′ along a whole length of an unsealed edge 242″ as indicated by arrow 228, flow across unsealed spacers 206 and flow out along the whole length of an opposite unsealed edge 244″, as indicated by arrow 228′, essentially perpendicularly to the flow of the feed stream. This way, membrane package 200′ facilitates the free flow of feed stream and the process stream perpendicularly to each other along the whole surface of spacers 204 and 206.

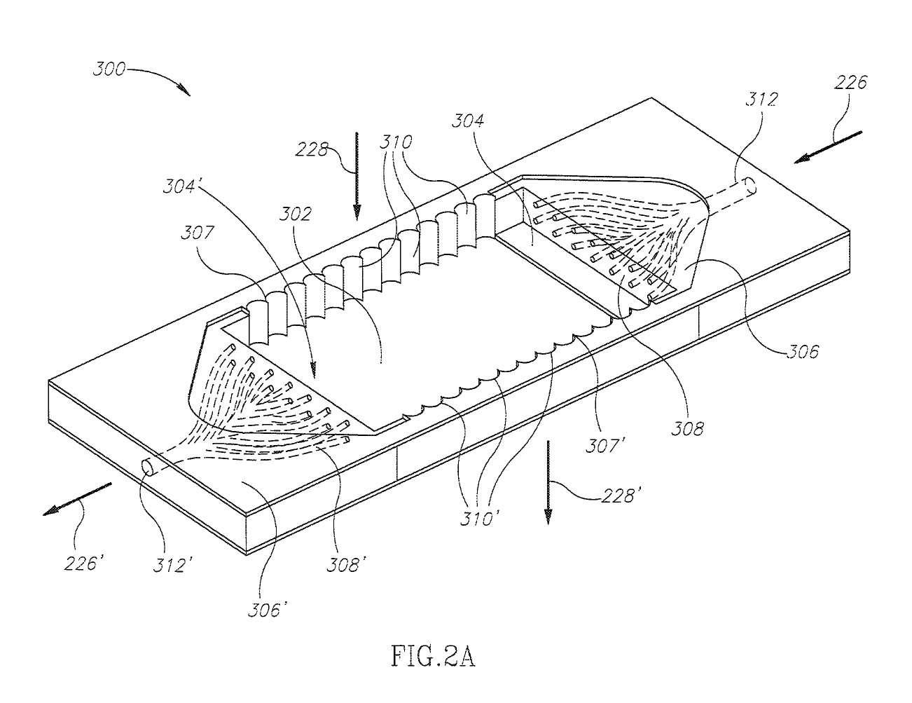

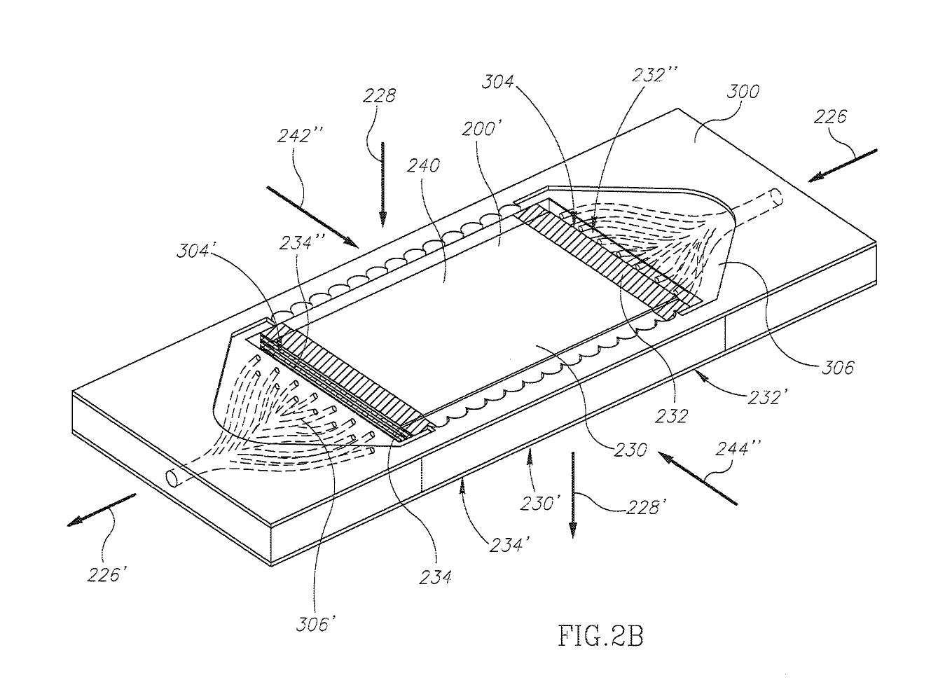

Reference is made to FIG. 2A, which schematically illustrates an, isometric view of an exemplary frame 300, in accordance with some embodiments of the invention. A frame, such as frame 300, may be a part of a membrane module, which may be a part of an apparatus adapted for diluting and/or concentrating a solution in a desalination process, in accordance with an embodiment of the invention. Frame 300 is adapted to support the membrane package and is further adapted to allow free flow of feed stream 226 and process stream 228 into the membrane package and free flow of feed stream 226′ and process stream 228′ out of the membrane package, while substantially preventing the streams from mixing with one another. Frame 300 is shaped so that the membrane package can be inserted and connected in predetermined areas to the frame, on three of the surfaces of each connected region with the bottom surfaces attached to the extending regions 304 and 304′ of the frame, as described hereinbelow.

According to some embodiments, frame 300 includes central section 302 configured to accommodate a membrane package such as membrane package 200′ of FIG. 1B (not shown in FIG. 2A but is shown as membrane package 200′ in FIG. 2B hereinbelow). Frame 300 further includes two opposite distribution channels compartments 306 and 306′ created for entry of feed stream 226 and its exit 226′ to and from the membrane package. Distribution channel compartments 306 and 306′ comprise branched channels 308 and 308′, respectively, adapted to conduct the flow of feed stream 226 and 226′ respectively. The thickness of distribution channels compartments 306 and 306′ part of the frame is lower than frame 300 total thickness by a thickness of spacer 206 (the spacer confined between two adjacent sleeves 202, see for example, in FIG. 1A). The direction of the feed stream flow through distribution channels compartments 306 and 306′ is arbitrary. Feed stream 226 may enter the membrane package through distribution channel compartment 306 and feed stream 226′ may exit the membrane package through distribution channel compartment 306′ or vice versa.

Frame 300 further comprises inlet port 312 and outlet port 312′ connected to distribution channels compartments 306 and 306′, respectively. Ports 312 and 312′ are disposed at the two ends of the plane of frame 300. In accordance with some embodiments, feed stream 226 may flow through inlet port 312 through distribution channels compartment 306, through the membrane package (not shown in FIG. 2A but is shown as membrane package 200′ in FIG. 2B herein below) and out as partly deionized feed stream 226′ through distribution channel compartment 306′ and through outlet port 312′ outside of frame 300. The feed stream flow may be in opposite direction to the described above, in other words the feed stream may flow from outlet port 312′ (which in fact acts as an inlet) through distribution channels compartment 306′, through the membrane package (not shown in FIG. 2A but is shown as membrane package 200′ in FIG. 2B hereinbelow) and out as feed stream 226′ through distribution channel compartment 306 and through inlet port 312 (which in fact acts as an outlet) outside of frame 300.

Central section 302 of frame 300 is defined by distribution channels compartments 306 and 306′ on two opposing sides thereof and by two side walls 307 and 307″ on the other two opposing sides thereof. Two side walls 307 and 307′ include recesses such as (but not limited to this particular shape) the tubular recesses 310 and 310′, disposed along the length of side walls 307 and 307′. Tubular recesses 310 and 310′ are configured to allow the flow of process stream 228 to the spacers disposed between the sleeves in the membrane package and the flow of process stream 228′ from these spacers in the membrane package, respectively. Tubular recesses 310 disposed on one side of wall 307 of frame 300 further allow entry of process stream 228 from the opening in the end plate into the membrane package (as will be described hereafter). Tubular recesses 310′ disposed on the opposite side wall 307′ of frame 300 allow process flow exit 228′ from the membrane package towards the opening in the respective end plate (as will be described hereafter).

As discussed hereinabove, frame 300 includes central section 302, which is suitable for the insertion of the membrane package. The membrane package is supported by opposite extending regions of the frame bottom surface 304 and 304′, of the thickness equal to the thickness of spacer 206 (see for example, in FIG. 1A). The membrane package may be attached to opposite extending regions 304 and 304′ of frame 300 at its connected regions bottom surfaces and to frame walls 307 and 307′ at its connected regions side surfaces by means of a connecting material, such as epoxies or other glue. According to some embodiments, membrane package 200′ may be further anchored in frame 300 by means of the protrusions of the connected region and the adapted shape of the frame walls 307 and 307′.

Frame 300 may comprise a plastic material, a composite material, and/or any other material or combination of materials adapted to substantially resist contact with feed stream 226, process stream 228, feed stream 226′, and process stream 228′.

Reference is made to FIG. 2B, which schematically illustrates an isometric view of exemplary membrane package 200′ inserted in exemplary frame 300, in accordance with an embodiment of the invention. A membrane package, such as membrane package 200′, and a frame, such as frame 300, may be a part of a membrane module, which may be a part of an apparatus adapted for diluting and/or concentrating a solution in a desalination process, in accordance with an embodiment of the invention. Optionally, the apparatus may form an acid and/or a basic solution in a neutralization process; diffuse a concentrated solution and a more dilute water source in an energy conversion process; selectively move ions in a solution, or optionally de-ionize the solution, as may be required by a desired process; and/or any combination thereof. Said apparatus may be adapted for use in processes such as ED, EDR, Donnan Dialysis, EDI, CEDI, and the like.

Membrane package 200′ is inserted into frame 300 and attached to opposite extending regions 304 and 304′ of frame 300 at its connected regions bottom surfaces 232′ and 234′ and to frame walls 307 and 307′ at its connected regions surfaces containing unsealed edges 242″ and 244″, by means of a connecting material, such as epoxies or other glues. The area of membrane package supporting regions 304 and 304′ is slightly larger than the area of the membrane package connected regions bottom surfaces 232′ and 234′. After the insertion of membrane package 200′ into frame 300, a small space is left between distribution channels compartments 306 and 306′ and the membrane package edges 232″ and 234″, allowing the uniform feed stream 226 flow from distribution channels compartment 306 into membrane package 200′ and uniform feed stream 226′ flow from membrane package 200′ to distribution channels compartment 306′ located at the opposite side of the frame. Inserted membrane package 200′ comprises exposed bottom surface. The area of the exposed bottom surface of membrane package 200′ equals to active area 230 of the membrane package. The inserted membrane package further comprises exposed top surface 240. The area of the exposed top surface equals to the total surface area of the membrane package (including active area 230 and connected regions surfaces 232 and 234).

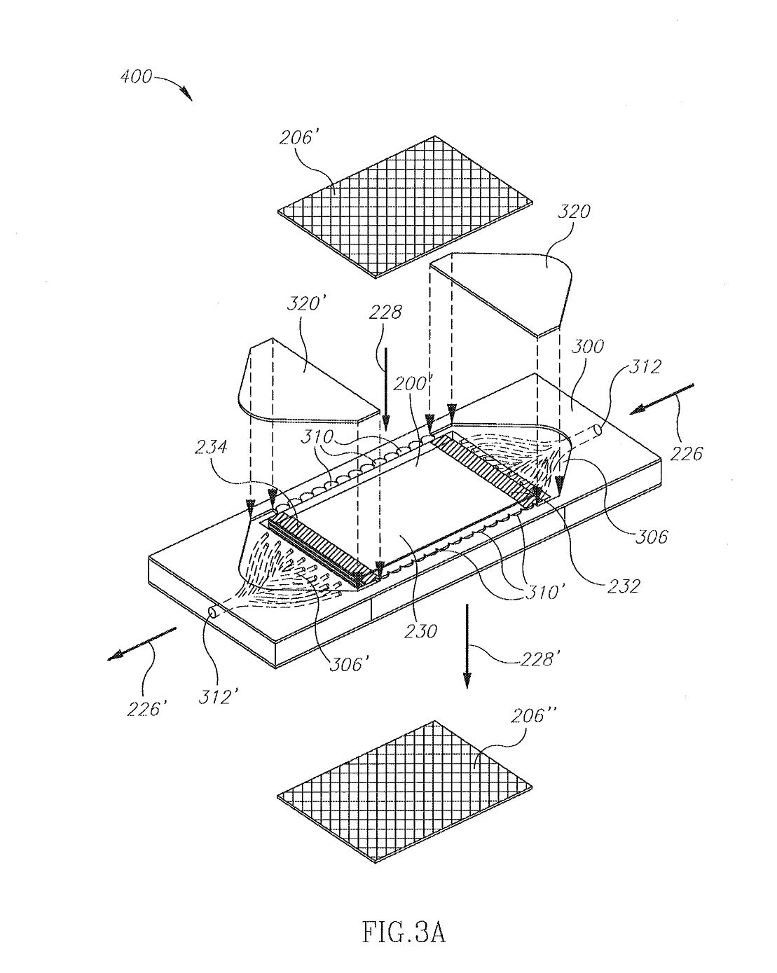

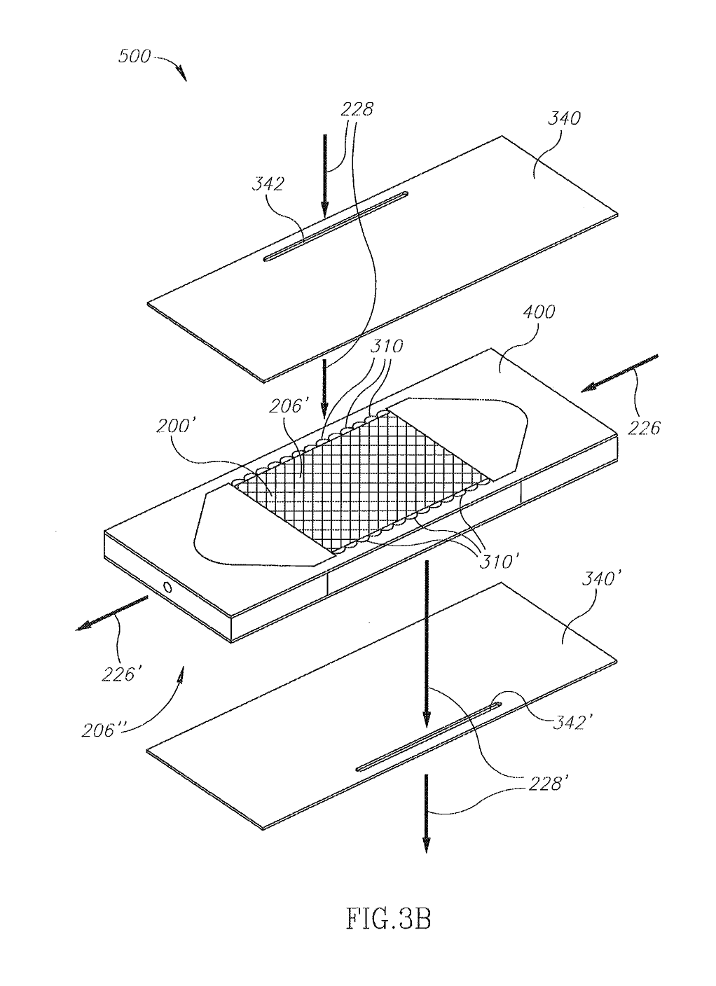

Reference is made to FIG. 3A, which schematically illustrates an exploded isometric view of an exemplary module 400, in accordance with another embodiment of the invention. A membrane module, such as membrane module 400, may be a part of an apparatus adapted for diluting and/or concentrating a solution in a desalination process, in accordance with an embodiment of the invention. Module 400 includes membrane package 200′ and frame 300. Module 400 further includes two spacers 206′ and 206″ of the same thickness as spacer 206 disposed between two adjacent sleeves 202 (see for example, in FIG. 1A). Spacer 206′ is attached to the top surface and spacer 206″ is attached to the bottom surface of membrane package 200′. The area of spacers 206′ and 206″ equals to the membrane package top and bottom active areas 230 and 230′, respectively. Spacer 206″ is attached to membrane package bottom active area surface between extending regions 304 and 304′ of frame 300, bringing the membrane package flush with the frame at the bottom part of module 400. Spacer 206′ is attached to the membrane package top active area surface 230. The attached spacers leave recesses 310 available for process stream 228 flow into the membrane package and recesses 310′ for process stream 228′ flow out of the membrane package. The module further comprises two closure plates 320 and 320′ of the same thickness as spacer 206, which are attached onto the frame above distribution channels compartments 306 and 306′ and to membrane package connected regions top surfaces 232 and 234 by means of a connecting material. The connecting material may comprise epoxies or other glues. Attaching closure plates 320 and 320′ to the fourth surface of the connected membrane regions fixes the membrane package inside the frame and encloses the entrances into the sleeves and the distribution channels into one sealed volume. Plates 320 and 320′ seal the volume left between distribution channel compartment 306 and membrane package edge 232″ and between distribution channel compartment 306′ and membrane package edge 234″, respectively, enclosing feed stream flow 226 and 226′ inside module 400. In this way, feed stream 226 and 226′ is completely enclosed inside module 400, allowing the feed stream flow into, through and from the module without assembly of electrodes and/or endplates on the module. Furthermore, attaching spacer 206 and plates 320 and 320′ brings membrane package 200′ flush with frame 300 at the top part of module 400.

In accordance with an embodiment of the invention, module 400 is adapted to allow a substantially free flow of feed stream 226 and process stream 228 through the module, the module comprising a relatively low hydrodynamic resistance to the flow of the two streams. Module 400 is further adapted to receive process stream 228 and to direct its and feed stream 226 flow such that the streams may flow through membrane package 200′ essentially perpendicular to one another, producing a process stream 228′ and a feed stream 226′, respectively, according to a predetermined process (for example, ED, or optionally EDR, Donnan dialysis, acidification, neutralization, EDI, CEDI, and the like).

Module 400 is additionally adapted to substantially prevent any mixing between any one or any combination of, feed stream 226, process stream 228, feed stream 226′, and process stream 228′.

Module 400 is further adapted to sterically separate feed stream 226 path from the process stream 228 path outside of membrane package 200′ to fully prevent the mixing of the streams. Module 400 allows the entry of feed stream 226 through inlet 312 and the exit of feed stream 226′ through outlet 312′ in one direction parallel to the plane of the module, whereas the entry of the process stream 228 through recesses 310 and exit of the process stream 228′ through recesses 310′ is oriented orthogonally to the feed stream flow, parallel to the same plane. The flow of feed stream 226 inside membrane package 200′ is perpendicular to the flow of process stream 228, while both the feed and the process streams flow in a plane parallel to the membrane package surface. Module 400 is further adapted to fully enclose feed stream 226 and 226′ inside the module.

Optionally, module 400 is additionally adapted to allow flow of process stream 228 and process stream 228′, from one module 400 to another module 400, without mixing of the process stream with the feed streams 226 and 226′, when the modules are arranged in a stacked configuration, as will be described hereinbelow.

Reference is made to FIG. 3B which schematically illustrates an isometric view of an exemplary stack 500, comprising module 400, in accordance with another embodiment of the invention. A stack, such as stack 500, may be a part of an apparatus adapted for diluting and/or concentrating a solution in a desalination process, in accordance with an embodiment of the invention. The apparatus comprising stack 500 may optionally be adapted for use in processes such as ED, EDR, Donnan Dialysis, EDI, CEDI, and the like. Apparatus 100 may form an acid and/or a basic solution in a neutralization process; diffuse a concentrated solution and a more dilute water source in an energy conversion process; selectively move ions in a solution, or optionally de-ionize the solution, as may be required by a desired process; and/or any combination thereof. In some embodiments of the invention, the apparatus comprising stack 500 may be used for Reversed Electrodialysis (RED), wherein passage of salt from a concentrate to a dilute creates a current due to the diffusion potential (while in regular ED a potential is applied which is high enough to drive salt from dilute into concentrated solution).

Stack 500 represents module 400 and further includes electrodes represented as end plates. The electrodes are attached to the top and the bottom surfaces of module 400 either by suitable external screws and o-rings on the electrodes (not shown) or permanently attached by epoxies or other glues. Electrode 340 is attached to the membrane module surface comprising spacer 206′ and electrode 340′ is attached to the membrane module surface comprising spacer 206″. The electrodes may comprise an o-ring (not shown). Top electrode 340 is provided with opening 342 and bottom electrode 340 is provided with opening 342, having a matching size to the process stream tubular recesses 310 inlet and tubular recesses 310′ outlet of frame 300, allowing process stream 228 entrance through electrode 340 and process stream 228′ exit through opposite electrode 340′. The electrodes may serve as end plates. The electrodes are connected to a DC voltage source (not shown) and are adapted to produce a direct current, which flows from one electrode to the other through stack 500 when feed stream 226 and 226′ and process stream 228 and 228′ flow through module 400, including through membrane package 200′. Electrode 340 may serve as an anode and electrode 340′ may serve as a cathode.

Electrode rinse solution is circulated through the electrode housings. Optionally, the electrodes are adapted to change polarity (cathode becomes the anode and the anode becomes the cathode) responsive to a reversing of polarity in the DC voltage source, a direction of direct current flow in stack 500 according to the polarity of the electrodes.

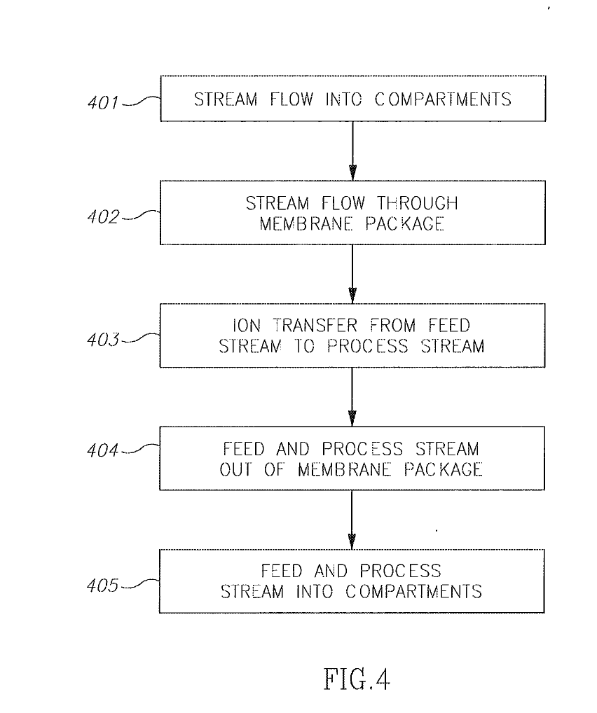

Reference is made to FIG. 4 which schematically illustrates a flow chart of an exemplary mode of operation of module 400 in accordance with an embodiment of the invention. For explanatory purposes, the exemplary mode of operation is based on an ED water desalination process.

[STEP 401] Feed stream 226 flows into compartment 306, comprising distribution channels 308 through inlet port 312 and process stream 228 flows from end plate 340, comprising opening 342 into recesses 310 compartment, both streams comprising salty water. Feed stream 226 and process stream 228 entering membrane package 200′ are conducted in perpendicular planes.

[STEP 402] Feed stream 226 flows from compartment 306, comprising distribution channels 308 into membrane package 200′ through substantially the whole length of the open edge of spacers 204. Feed stream 226 flow from compartment 306 into spacers 206 is substantially prevented as edge 232″ of the membrane package is connected, leaving spacers 206, leading into the compartment, covered by a sealing material. Process stream 228 flows from tubular recesses 310 into membrane package 200′ through substantially the whole length of the open edge of spacer 206. Process stream 228 flow from recesses 310 into spacers 204 is substantially prevented, as spacer 204 is disposed inside sealed membrane sleeve 202. Feed stream 226 flow and process stream 228 flow across membrane package 300 are essentially perpendicular to one another.

[STEP 403] Ions from feed stream 226 are transferred through cation exchange membrane 208 and anion exchange membrane 210 to process stream 228 as the streams flow through spacers 204 and 206, respectively, while a direct current flows through membrane module 400 (a DC voltage source is connected across membrane module 400).

[STEP 404] Feed stream 226, in the form of feed stream 226′ with composition changed by the transfer of ions through the membranes, exits membrane package 200′ through substantially a whole length of an open edge of spacer 204 opposite the open edge through which the feed stream entered. Process stream 228, in the form of process stream 228′ with composition changed by the transfer of ions through the membranes, exits membrane package 200′ through substantially a whole length of an open edge of spacer 206 opposite the open edge through which the feed stream entered. The flow of feed stream 226′ and process stream 228′ are essentially perpendicular to one another as they exit membrane package 200′.

[STEP 405] Feed stream 226 flows into compartment 306′, comprising distribution channels 308′ and is conducted out of module 300 through outlet 312′. Process stream 228 flows into compartment 304′ and is conducted out of module 300. Feed stream 226′ and process stream 228′ exiting membrane package 300 are conducted in the perpendicular planes, preventing the mixing of the two streams.

The exemplary mode of operation described is not intended to be limiting in any form or manner. It may be evident to a person skilled in the art that other modes of operation are possible, which may include variations in the steps performed including the sequence in which they are performed.

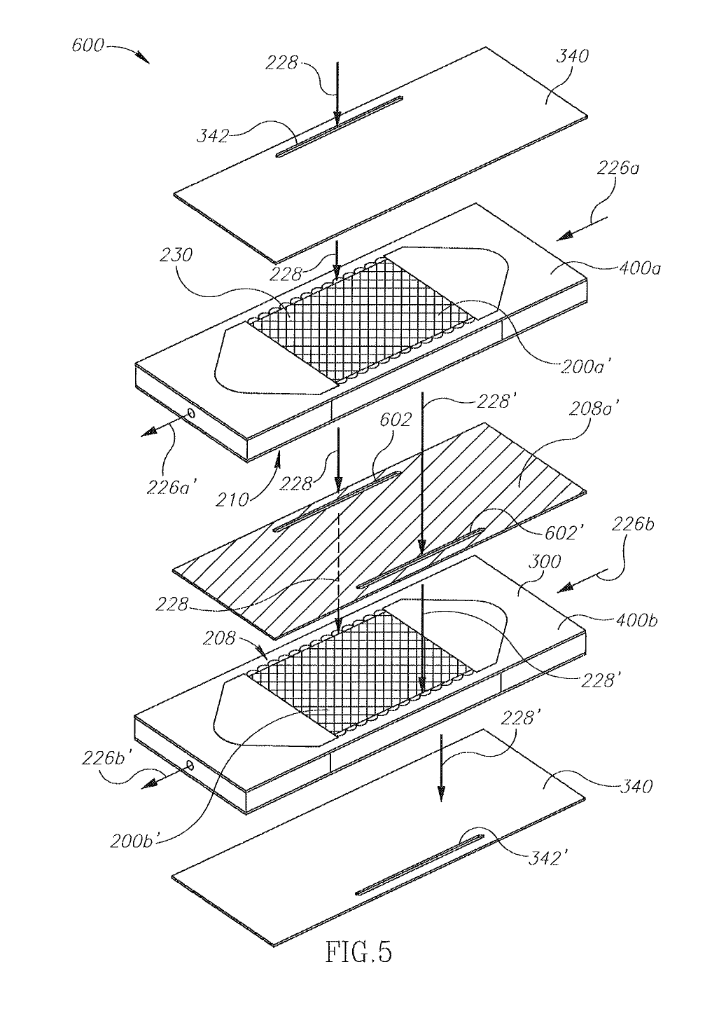

Reference is made to FIG. 5, which schematically illustrates an exploded isometric view of a multi-modular stack 600, comprising a plurality of modules (generally referred to as modules 400), such as modules 400a and 400b, in accordance with an embodiment of the invention. A multi-modular stack, such as multi-modular stack 600, may be a part of an apparatus adapted for diluting and/or concentrating a solution in a desalination process, in accordance with an embodiment of the invention. Multi-modular stack 600 may be configured into a vertical stack of modules 400 by placing one module on top of another module. Optionally, multi-modular stack 600 may be configured into a horizontal stack of modules 400 by placing one module next to another module. The exemplary multi-modular stack comprises two modules solely for ease of description.

Multi-modular stack 600 may be a part of an apparatus adapted to perform ED, in accordance with an embodiment of the invention. Optionally, multi-modular stack 600 may be a part of an apparatus adapted to perform EDR. Optionally, multi-modular stack 600 may be a part of an apparatus adapted to perform acidification and/or neutralization. Optionally, multi-modular stack 600 may be a part of an apparatus adapted to perform Donnan apparatus. Optionally, multi-modular stack 600 may be a part of an apparatus adapted to perform EDI or CEDI. Optionally, multi-modular stack 600 may be a part of an apparatus adapted to selectively move ions in a solution, or optionally de-ionize the solution.

Multi-modular stack 600 additionally comprises two electrodes: a cathode and an anode, each electrode serving as end plate 340 and 340′ at each end of multi-modular stack 600. For example, end plate 340 may comprise the cathode and end plate 340′ may comprise the anode. The electrodes are connected to a DC voltage source (not shown) and are adapted to produce a direct current, which flows from one electrode to the other through multi-modular stack 600 when feed stream 226a and process stream 228 and feed stream 226b and process stream 228 flow through modules 400a and 400b respectively, including through membrane packages 200a′ and 200b′. Optionally, the electrodes are adapted to change polarity (cathode becomes the anode and the anode becomes the cathode) responsive to a reversing of polarity in the DC voltage source, a direction of direct current flow in stack 500 according to the polarity of the electrodes. The electrodes comprise an o-ring (not shown). In accordance with an embodiment of the invention, end plate 340 comprises opening 342 adapted to allow process stream 228 entering multi-modular stack 600 to flow to each one of modules 400a and 400b through recesses 310 of frame 300 of the respective module and to flow into the membrane packages of the respective module. Oppositely positioned end plate 340′ comprises opening 342′ adapted to allow the process stream 228′ exiting multi-modular stack 600, with composition changed by the transfer of ions inside the membrane packs, to flow from each one of modules 400a and 400b through recesses 310′ of frame 300 of the respective module. Multi-modular stack further comprises a plurality of cation exchange membranes (generally referred to as cation exchange membranes 208′) such as cation exchange membrane 208a′ and a plurality of o-rings, wherein one cation exchange membrane 208′ and one o-ring (not shown) are confined between each two modules 400. Cation exchange membrane 208a′ is attached to module 400b on the perimeter of frame 300, by means of a connecting material, leaving active area 230 of the membrane package uncovered by the connecting material. The connecting material may comprise epoxies or other glues. The surface area of cation exchange membrane 208a′ equals to the surface of membrane modules 400a and 400b. Cation exchange membrane 208a′ is attached to module 400b side comprising cation exchange membrane 208 of the membrane package. An o-ring is added to the opposite side of module 400a, comprising anion exchange membrane 210 and module 400a is attached to module 400b. The obtained hydrodynamic resistance between modules 400a and 400b is similar to the hydrodynamic resistance inside the membrane package. Practically, the obtained cell, comprising cation exchange membrane of module 400b, spacer 208 of module 400b and attached membrane 208a′, is not another deionization cell, as it is confined between two cation exchange membranes. The o-ring disposed between module 400a and attached cation exchange membrane 208a′ provides a free-of-leakage flow of process stream 228 and 228′ during its passage through the modules. The attached membrane is provided with openings 602 and 602′, so that upon the attachment of the membrane, recesses 310 and 310′ of the modules are retained open so that process stream 228 which enters the multi-modular stack through module 400a may flow from module 400a to module 400b through opening 602 in attached cation exchange membrane 208a′ and process stream 228′ may flow from module 400a to module 400b through opening 602′ in attached cation exchange membrane 208a′ and exit the multi-modular stack through module 400b. The process stream passes through the plurality of modules of the multi-modular stack. The feed stream is divided between all modules 400 of the multi-modular stack to a plurality of feed streams such as 226a and 226b, wherein each portion of the feed stream enters specific module and is confined inside each module of the stack, preventing the mixing of the feed and the process streams. In accordance to an exemplary embodiment, feed stream 226a enters and flows through module 400a and feed stream 226a′ exits module 400a, while feed stream 226b enters and flows through module 400b and feed stream 226b′ exits module 400b. Such discrete distribution of the feed stream among the modules, in contrast to the flow of process stream 228 and 228′ through all the modules, allows a convenient interchanging of the modules, whenever required.

In the description and claims of embodiments of the present invention, each of the words, “comprise” “include” and “have”, and forms thereof, are not necessarily limited to members in a list with which the words may be associated.

The invention has been described using various detailed descriptions of embodiments thereof that are provided by way of example and are not intended to limit the scope of the invention. The described embodiments may comprise different features, not all of which are required in all embodiments of the invention. Some embodiments of the invention utilize only some of the features or possible combinations of the features. Variations of embodiments of the invention that are described and embodiments of the invention comprising different combinations of features noted in the described embodiments will occur to persons with skill in the art.

1. A membrane module comprising:
a membrane package comprising at least two membrane sleeves, wherein each sleeve comprises a first and a second membrane sealed together along two parallel edges of said first and said second membranes, and wherein said two membrane sleeves are connected along two edges perpendicular to the sealed edges of said first and said second membranes, forming two membrane package sides having unsealed sleeve edges, wherein the membrane package is configured to allow essentially free flow of a first stream inside the sleeves and essentially free flow of a second stream between each two adjacent sleeves, wherein the first stream flow is perpendicular to the second stream flow; and
a frame, configured to support the membrane package, such that part of each of the four surfaces perpendicular to the two membrane package sides having unsealed sleeves edges is affixed to predetermined areas in the frame, leaving the unsealed sleeves open to the flow of the first stream and forming a module having separate spaces configured to facilitate separate flows of the first stream and the second stream through the membrane package.

2. The membrane module according to claim 1, wherein the membrane package further comprises at least two spacers, each disposed inside each membrane sleeve, and at least one spacer, disposed between two adjacent membrane sleeves.

3. The membrane module according to claim 2, wherein the membrane package is configured to allow the flow of the first stream through the spacer disposed inside the membrane sleeve and the flow of the second stream through the spacer disposed between each two adjacent sleeves.

4. The membrane module according to claim 1, wherein the first stream flow and the second stream flow are not mixing with one another.

5. (canceled)

6. The membrane module according to claim 1, wherein the first membrane is a cation exchange membrane and a second membrane is an anion exchange membrane.

7. (canceled)

8. The membrane module according to claim 1, wherein the first membrane and the second membrane are cation exchange membranes.

9. The membrane module according to claim 1, wherein the frame comprises distribution compartments on two opposite sides, configured to facilitate the first stream flow through the membrane package.

10. The membrane module according to claim 9, wherein the frame comprises recesses on two other opposite sides, configured to facilitate the second stream flow through the membrane package.

11. The membrane module according to claim 1, configured to fully enclose the first stream inside said membrane module.

12. The membrane module according to claim 1, wherein the first stream flow into said membrane module and out of said membrane module and the second stream flow into said membrane module and out of said membrane module are conducted in perpendicular planes.

13. (canceled)

14. A multi-modular stack comprising at least two membrane modules and at least one membrane, disposed between the modules, wherein each membrane module comprises:
a membrane package comprising at least two membrane sleeves, wherein each sleeve comprises a first and a second membrane sealed together along two parallel edges of said first and said second membranes, and wherein said two membrane sleeves are connected along two edges perpendicular to the sealed edges of said first and said second membranes, forming two membrane package sides having unsealed sleeve edges, wherein the membrane package is configured to allow essentially free flow of a first stream inside the sleeves and essentially free flow of a second stream between each two adjacent sleeves, wherein the first stream flow is perpendicular to the second stream flow; and
a frame, configured to support the membrane package, such that part of each of the four surfaces perpendicular to the two membrane package sides having unsealed sleeves edges is affixed to predetermined areas in the frame, leaving the unsealed sleeves open to the flow of the first stream and forming a module having separate spaces configured to facilitate separate flows of the first stream and the second stream through the membrane package.

15. The multi-modular stack according to claim 14, further comprising at least one o-ring disposed between said membrane modules.

16. The multi-modular stack according to claim 14, wherein the membrane disposed between the membrane modules is configured to allow free from leakage flow of the second stream through the membrane modules.

17. The multi-modular stack according to claim 14, wherein the second stream passes through all the modules and the first stream is divided between all the modules, wherein each portion of the first stream enters specific module and is confined inside each module.

18. The multi-modular stack according to claim 14, wherein the flow of the first stream and of the second stream across the stack is conducted in perpendicular planes.

19. The multi-modular stack according to claim 14, wherein each membrane module is readily removable and interchangeable.

20. The multi-modular stack according to claim 14, configured to be used in electrodialysis ED, electrodialysis reverse ED (EDR), Donnan Dialysis, Electro-deionization (EDI), Continuous Electro-deionization (CEDI), and/or Reversed Electrodialysis (RED), or any combination thereof.

21. (canceled)

22. (canceled)

23. A method for fluid deionization, comprising passing a first stream and a second stream through a membrane module, comprising at least one membrane package and a frame, wherein the first stream flow to the membrane package is conducted through distribution compartments disposed on two opposite sides of the frame and the second stream flow to the membrane package is conducted through recesses disposed on two other opposite sides of the frame.

24. The method according to claim 23, further comprising passing a first stream and a second stream through a multi-modular stack, comprising at least two membrane modules and at least one membrane, disposed between the modules, wherein the first stream flow is divided between all modules of the multi-modular stack and the second stream flow is conducted through all modules and the membranes of the multi-modular stack.

25. The method according to claim 23, wherein the first stream is a feed stream and the second stream is a process stream or wherein the first stream is a process stream and the second stream is a feed stream.

26-28. (canceled)
